(19) United States
(12) Patent Application Publication
(10) Pub. No.: US 2026/0162229 A1
(43) Pub. Date: Jun. 11, 2026

(54) ADAPTIVE LOCALIZED NOISE REDUCTION FOR COLOR AND INFRARED DATA CHANNEL PROCESSING

(71) Applicant: NVIDIA Corporation, Santa Clara, CA (US)

(72) Inventors: Devayani VERNEKAR, Boston, MA (US); Animesh KHEMKA, Fremont, CA (US); Gopal Triplicane VENKATESAN, Sunnyvale, CA (US)

(21) Appl. No.: 18/970,242

(22) Filed: Dec. 5, 2024

(51) Int. Cl. G06T 5/70; G06T 3/4015; G06T 5/20; G06T 5/92; H04N 9/73

(52) U.S. Cl. CPC G06T 5/70; G06T 3/4015; G06T 5/20; G06T 5/92; H04N 9/73; G06T 2207/10024; G06T 2207/20182

(57) ABSTRACT

In various examples, localized noise reduction adaptation for color and infrared data channel processing is provided. Embodiments provide systems and methods for an ISP pipeline that address noise components introduced into RGB color channels due to adaptive adjustments to RGB color channels, such as local adaptation-based IR subtraction adjustments. Cumulative noise gain information may be communicated in the form of an adaptive noise gain map. A noise model adjustment function may use correction information from the adaptive noise gain map to dynamically compute supplemental noise adjustments that represent noise corrections relative to a sensor noise profile used by a noise reduction stage of the ISP for noise correction. Application of the supplemental noise adjustments to the sensor noise profile may be represented as a composite noise map that is input to the noise reduction stage.

### BACKGROUND

Advanced Driver Assistance Systems (ADASs) represent an evolving technology in the automotive industry to provide features such as occupant monitoring systems (OMSs), including Driver Monitoring Systems (DMSs). OMSs perform real-time assessments of driver and occupant presence, gaze, alertness, or other conditions for reliable detection and recognition of safety-critical information. Increasingly, the optical image sensors used to capture image data for these OMS assessments are devices that capture image frames that include visual spectrum color data (e.g., red, blue, green (RGB) data) as well as non-visible infrared (IR) data. For example, an OMS optical image sensor may comprise a monocular optical image sensor, such as a camera, that captures both color and IR image streams (RGB-IR) as image frames of a vehicle interior.

### SUMMARY

Embodiments of the present disclosure relate to localized noise reduction adaptation for color and infrared data channel processing.

In contrast to traditional image signal processing (ISP) pipelines, embodiments of this disclosure provide an ISP pipeline that addresses the issues of deviant noise components that may be introduced into RGB color channels due to adaptive ISP pipeline adjustments to the RGB color channels, such as local adaptation-based IR subtraction adjustments. Non-limiting examples of image processing that may produce localized noise gain in visible wavelength color data channels of the ISP pipeline include locally adaptive IR subtraction, locally adaptive color compensation (e.g., adaptive white balance and color correction), lens shading correction, and/or other color channel adjustments and/or digital filtering that may produce non-uniform noise gains across an image frame. A side channel may cumulatively keep track of, and accumulate, noise gains associated with each adjustment to RGB color channels that affect noise gain, and communicate the accumulated noise gain information to the locally adaptive noise reduction function. In some embodiments, accumulated noise gain information may be communicated in the form of an adaptive noise gain map. In some embodiments, the locally adaptive noise reduction function may comprise a noise model adjustment function that uses the pixel-by-pixel correction information from the adaptive noise gain map to dynamically compute a set of supplemental noise adjustments. The supplemental noise adjustments may represent additional noise corrections relative to a sensor noise profile used by the noise reduction stage for noise correction (e.g., a sensor noise model, Sigma noise value curve, etc.). The supplemental noise adjustments provide pixel-level noise corrections that are applied together with corrections indicated by the sensor noise profile—to ensure that a more uniform noise reduction is achieved for the entire image while simultaneously restoring colors consistently throughout the image.

Application of the supplemental noise adjustments to the sensor noise profile may be represented as a composite noise map that is input to the noise reduction stage. To produce the composite noise gain map, the noise model adjustment function may apply the adaptive noise gain map to bias the Sigma noise value curve used by the noise reduction stage to adjust for sensor noise. That is, based on the noise gain factors indicated by the adaptive noise gain map for a pixel color channel, the noise model adjustment function may bias—at the individual pixel level—the point on the Sigma noise value curve (e.g., by moving up or down the curve) used to determine the amount of noise reduction applied by the noise reduction stage for a pixel. The composite noise gain map thus represents the adjusted Sigma noise value curve values individually adjusted for each pixel based on the adaptive noise gain map.

### BRIEF DESCRIPTION OF THE DRAWINGS

The present systems and methods for localized noise reduction adaptation for color and infrared data channel processing are described in detail below with reference to the attached drawing figures, wherein:

FIG. 1 is a data flow diagram for a process for an example locally adaptive noise reduction for an adaptive IR correction-based ISP system, in accordance with some embodiments of the present disclosure;

FIG. 2 is a data flow diagram for an example locally adaptive ISP pipeline, in accordance with some embodiments of the present disclosure;

FIG. 3 is a flow chart illustrating an example method for locally adaptive noise reduction for an adaptive IR correction-based ISP, in accordance with some embodiments of the present disclosure;

FIG. 4A is an illustration of an example autonomous vehicle, in accordance with some embodiments of the present disclosure;

FIG. 4B is an example of camera locations and fields of view for the example autonomous vehicle of FIG. 4A, in accordance with some embodiments of the present disclosure;

FIG. 4C is a block diagram of an example system architecture for the example autonomous vehicle of FIG. 4A, in accordance with some embodiments of the present disclosure;

FIG. 4D is a system diagram for communication between cloud-based server(s) and the example autonomous vehicle of FIG. 4A, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

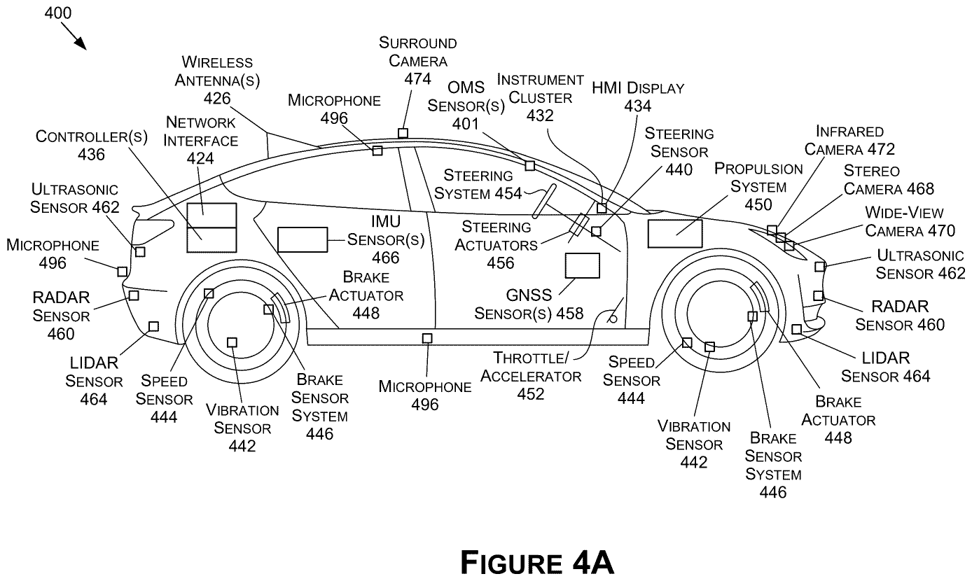

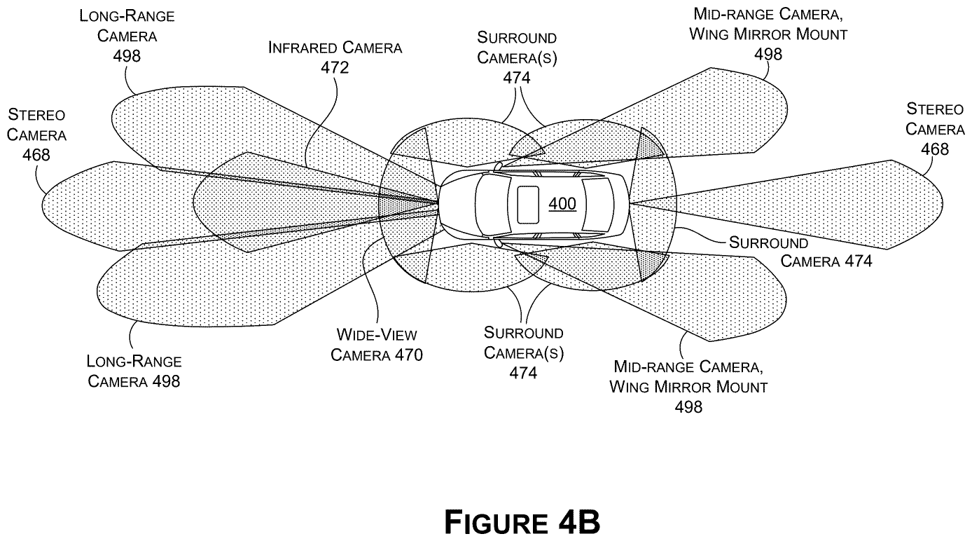

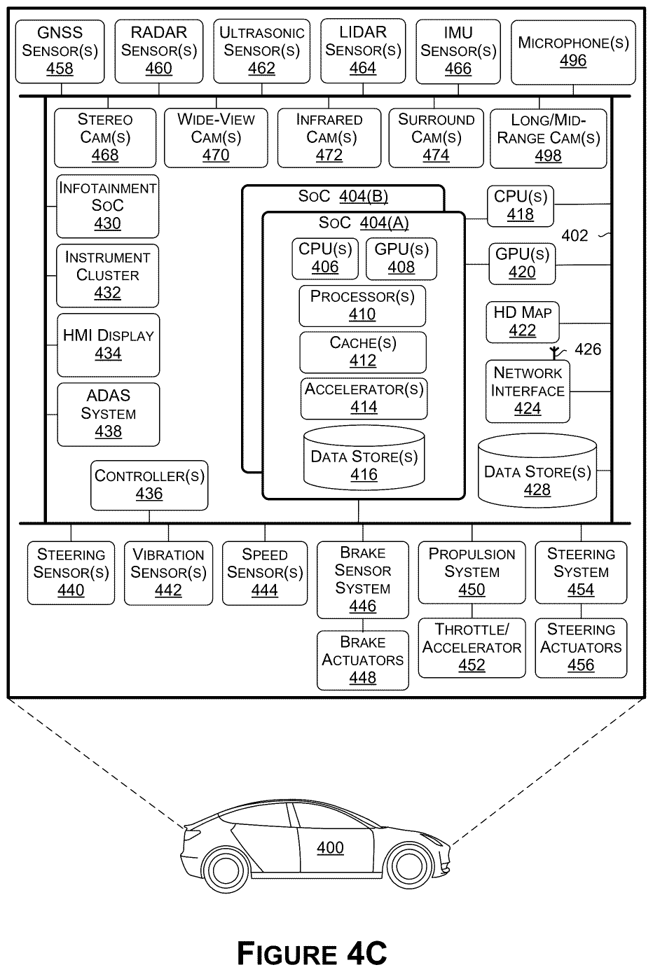

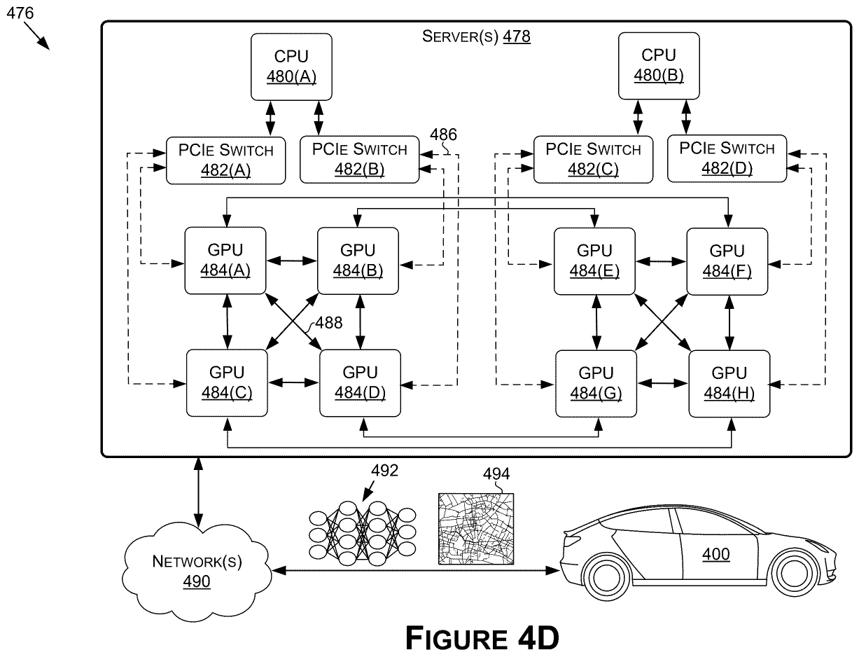

Systems and methods are disclosed related to localized noise reduction adaptation for color and infrared data channel processing. Although the present disclosure may be described with respect to an example autonomous or semi-autonomous vehicle or machine 400 (alternatively referred to herein as “vehicle 400” or “ego machine 400,” an example of which is described with respect to FIGS. 4A-4D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to image signal processing for autonomous driving, this is not intended to be limiting, and the systems and methods described herein may be used in augmented reality, virtual reality, mixed reality, robotics, security and surveillance, autonomous or semi-autonomous machine applications, and/or any other technology spaces where local adaptive image signal processing may be used.

Because image sensors (such as complementary metal-oxide-semiconductor (CMOS) sensors) have a strong response to IR and near-IR wavelength light, many RGB and monochrome cameras include an IR-cut filter (e.g., a coating or element in the camera lens stack) to at least partially remove IR wavelength light from RGB color channels. However, for image sensors that are intended to provide RGB-IR image streams, an IR-cut filter is less advantageous, as it attenuates the sensor's ability to obtain an accurate measurement of IR wavelength light. For RGB-IR sensors, a substantial amount of IR wavelength light can therefore still reach and affect the values of the RGB color data channels. Although IR light does accurately convey details about structures, objects, and/or backgrounds of a scene, it does so based on a spectrum of light not visible to human beings. Computer graphics renderings of a scene based on IR light therefore may not visually appear the same as the scene would appear to a human being with the naked eye. As such, with respect to color image processing of RGB color data, the presence of IR data in the one or more color channels has been considered a source of contamination and noise. As used herein, IR data refers to data representing non-visible infrared wavelengths of electromagnetic radiation (IR light) in captured image data, and may include, for example, wavelengths categorized as near-infrared, infrared, and/or far-infrared.

Image Signal Processors (ISPs) that process image sensor RGB-IR image data may separate out color information by subtracting an estimate of IR contribution at each color channel of a pixel early in the pipeline. That is, in some embodiments, an RGB-IR pixel refers to a construct of individual pixels that are each associated with a photosensitive sensor element (e.g., a photosite) of the image sensor for that pixel assigned to a color channel. The color channel associated with a photosite of an image sensor is in part a function of the pattern of the color filter array (CFA) filter used with the image sensor, and what color the CFA filter passes to the photosensitive sensor element for a pixel. Where the CFA filter passes red light to the photosensitive sensor element, then the color channel for the pixel is a red color channel. Where the CFA filter passes green light to the photosensitive sensor element, then the color channel for the pixel is a green color channel. Where the CFA filter passes blue light to the photosensitive sensor element, then the color channel for the pixel is a blue color channel. Where the CFA filter passes IR light to the photosensitive sensor element, then the color channel for the pixel is an IR channel. RGB color channels for a pixel are generally formed in an ISP by correcting RGB color channel values of the pixel for an IR component (which may be established based on data from an IR channel). When the ISP receives the raw image data from the camera, for the R, G, and B color channels associated with the pixels of an image frame, a global IR estimate for the image based on IR channel measurements is subtracted, and the remaining values in the R, G, and B color channels are used as the R, G, and B color data. The resulting R, G, and B color channels are then processed separately by the ISP.

Some existing image signal processing techniques separate the color information from IR information in RGB color channels by subtracting a global estimate of the IR intensity to provide color images having acceptable image quality (IQ) consistent with human vision and machine-perception needs. IR channel subtraction operations can, however, result in image artifacts in the RGB color channels if, for example, tonal values are clipped or close to being clipped (e.g., where any of the RGB color and/or IR intensities have experienced a non-linear change in values such as saturation), and/or where an IR over color ratio (e.g., IR/R, IR/B, or IR/G) is close to or higher than 1.0. These artifacts can occur in an image due to several reasons including overexposure, illumination characteristics, and object reflectance. Moreover, signal-to-noise ratio (SNR) degradation can result in areas of mid and low tones that contain critical features for detection and perception results. That is, the SNR could be degraded in low and mid tone areas that represent details of critical features if the IR estimate is subtracted. While reducing the amount of IR subtracted from the color estimates on a frame-by-frame basis can alleviate image artifacts and SNR degradation in some situations, frame-by-frame global tuning of IR subtraction cannot consistently improve image quality (IQ) across a wide variety of scenes.

Other proposed image signal processing techniques may implement an ISP pipeline that includes a locally adaptive IR adjustment function that varies the amount of luminance value subtracted from each color pixel for IR correction purposes, based on tonal and IR to color ratio metrics measured in the vicinity of the pixel. Localized corrections are applied based, for example, on a combination of IR over color ratio for pixels, and tonal level metrics in a pixel's neighborhood. The ISP pipeline may estimate a ratio of IR over color, and apply an attenuation to the IR subtraction (e.g., scale the IR subtraction) to retain residual color information that otherwise might be lost. As opposed to global tuning of IR subtraction, an individual IR value estimate is computed for a pixel based on an immediate pixel neighborhood around that pixel where that immediate pixel neighborhood may be referred to as a pixel's local support region. However, when using local adaptation-based IR adjustments, issues that may arise in downstream processing include, for example, color fidelity and distortion of noise profiles. Locally adaptive IR adjustments can mitigate image color artifacts by varying the amount of IR subtracted locally based on local tonal level and IR over color ratio metrics. The partial subtraction of IR changes the color ratios locally and may result in inconsistent color balance in different regions of the image—which in some instances may be corrected by commensurate adaptation applied during white balance and color correction stages of the pipeline to render proper color consistently throughout the image. That said, this local variation in IR subtraction level and subsequent color correction may lead to distortion of the noise profile of pixels in the immediate pixel neighborhood. In an image signaling pipeline of an ISP, a noise reduction stage is typically applied to the individual R, G, and B color channels, along with other adjustments performed by other pipeline stages such as, but not limited to, a demosaic stage, a white balance stage, a tone mapping stage, and/or a color correction stage. In some embodiments, an image signaling pipeline may include other stages, such as a lens shading correction stage that adjusts color channels to remove vignetting effects. The noise reduction stage operates based on a device noise profile characterized in the lab for the particular sensor module that captures the image(s) being processed. For example, for a given signal level, a Sigma noise value may be characterized in the lab and represented by a noise model (e.g., a curve) programmed into the noise reduction stage. As such, distortion of the noise profile of the image data introduces a non-uniform noise component not accounted for by the Sigma noise value curve used by the noise reduction stage such that non-uniform noise (e.g., the noise component caused by locally adaptive IR adjustments) remains in the color channels even after processing by the noise reduction stage.

In contrast to traditional ISP pipelines, embodiments of this disclosure provide an ISP pipeline that addresses the issues of deviant noise components that may be introduced into RGB color channels due to ISP pipeline adjustments such as local adaptation-based IR adjustments (e.g., IR subtraction) to the RGB color channels. In some embodiments, based on locally adapted IR subtraction corrections performed by a locally adaptive IR-correction function (e.g., stage) of the ISP pipeline, IR correction information (e.g., about how much IR has been subtracted) may be passed to a locally adaptive noise reduction function of the ISP pipeline to apply noise reduction adjustments that may have been otherwise underestimated by the standard ISP noise reduction stage. Pixel-by-pixel IR correction information and/or color correction information performed by one or more ISP pipeline stages may be passed through a side channel to the locally adaptive noise reduction function. A side channel may cumulatively keep track of and accumulate noise gains associated with each adjustment to RGB color channels that affect noise gain, and communicate the accumulated noise gain information to the locally adaptive noise reduction function. In some embodiments, accumulated noise gain information may be communicated in the form of an adaptive noise gain map. At least one advantage of the disclosed ISP pipeline and its locally adaptive noise reduction function is the ability for the ISP pipeline to adapt denoising locally based on various local image processing metrics, thus robustly providing the best possible denoising locally and globally. The locally adaptive noise reduction function provides automatic local denoising adjustment and enhances tuning flexibility so that good IQ can be achieved over a much wider range of scenes.

In some embodiments, a locally adaptive noise reduction function may comprise a noise model adjustment function that uses the pixel-by-pixel correction information accumulated by the side channel to dynamically compute supplemental noise adjustments. The supplemental noise adjustments may represent additional noise corrections relative to the sensor noise profile used by the noise reduction stage (e.g., a sensor noise model, Sigma noise value curve, etc.). That is, in some embodiments, the supplemental noise adjustments provide pixel-level noise corrections that are applied together with corrections indicated by the sensor noise profile—to ensure a more uniform noise reduction is achieved for the entire image while simultaneously restoring colors consistently throughout the image. Application of the supplemental noise adjustments to the sensor noise profile may be represented as a composite noise map that is input to the noise reduction stage.

The locally adaptive noise reduction function may be implemented as a distinct stage of the ISP pipeline, and/or integrated into the standard ISP noise reduction stage. In at least some embodiments, the noise model adjustment function computes a pixel-by-pixel noise gain factor representing adjustments made to one or more color channels by the ISP pipeline that affect a noise gain for those color channels. In some embodiments, the noise model adjustment function generates an adaptive noise gain map (e.g., a noise gain image) that correlates pixel-wise with the input image being processed such that a pixel location on the adaptive noise gain map indicates the computed noise gain for each color channel of the corresponding pixel location on the input image. To implement deviant noise reduction, a composite noise gain map, derived from the adaptive noise gain map and the sensor noise profile, may be used as an input to the noise reduction stage of the ISP pipeline to control noise corrections applied to the color data channels. To produce the composite noise gain map, the noise model adjustment function may apply the adaptive noise gain map to bias the Sigma noise value curve used by the noise reduction stage to adjust for sensor noise. That is, based on the noise gain factors indicated by the adaptive noise gain map for a pixel color channel, the noise model adjustment function may bias—at the individual pixel level—the point on the Sigma noise value curve (e.g., by moving up or down the curve) used to determine the amount of noise reduction applied by the noise reduction stage for a pixel. The composite noise gain map thus represents the adjusted Sigma noise value curve values individually adjusted for each pixel based on the adaptive noise gain map. The resulting noise reduction adjustments performed on the image pixel values by the noise reduction stage thus compensate for both sensor-introduced noise and noise gain in color channels introduced by ISP pipeline adjustments. As described in further detail herein, noise gain values for pixels may be accumulated as adjustments that are applied to the RGB color channels by the various stages of the ISP pipeline. The accumulation of noise gain that contributes to the adaptive noise gain map may be collected using a side channel that feeds channel adjustment data (e.g., data channel adjustment factors) to the locally adaptive noise reduction function.

As previously discussed, non-limiting examples of channel processing that may produce localized noise gain in visible wavelength color data channels of the ISP pipeline include adaptive IR subtraction and adaptive white balance and color correction stages.

An adaptive IR subtraction process may cause an increase in a pixel's color channel noise gain, where the amount of noise is dependent on a mixture between the original pixel variance (e.g., which may be determined from an estimated Bayer signal value), IR variance (e.g., which may be determined from an estimated IR signal value used in the process of adaptive IR subtraction), and a percentage of the IR signal subtracted from a color channel. The noise resulting from the mixture can be modeled as the quadrature summation of noise in each individual source before the mixing. For example, in some embodiments, adaptive IR subtraction may be computed based on the expression:

$${p}_{e s t}^{′} ( x , y , ch ) = F ( x , y ) ( finalscale ( x , y ) * [ {p}_{e s t} ( x , y , ch ) , - k ( x , y , ch ) * {IR}_{e s t} ( x , y ) ] )$$

where: x,y=pixel location, ch=Bayer channel (r,g,b), pₑₛₜ (x,y,ch)=estimated Bayer signal value, IRₑₛₜ (x,y)=estimated IR channel signal value, p′ₑₛₜ (x,y,ch)=new Bayer signal value after IR subtraction, k(x,y,ch)=IR subtraction factor (where k∈[0,1]), finalscale(x,y)=factor to rescale signal to original level before IR subtraction (dependent on k), and F(x,y)=IR subtraction adaptation function. The effect of adaptive IR subtraction on the noise variance of a color channel may be expressed as:

$${σ}_{{post}_{IRsubtract}}^{2} ( x , y , ch ) = {finalscale ( x , y )}^{2} * ( {σ}_{p}^{2} ( x , y , ch ) + {k}^{2} ( x , y , ch ) {σ}_{IR}^{2} ( x , y ) )$$

where: σₚ (x,y,ch)=noise variance of estimated Bayer signal p, and σ_{IR} (x,y)=noise variance of estimated IR signal. Thus, adaptive IR subtraction increases the noise variance depending on the estimated IR signal being subtracted. To estimate these changes to the noise model, IR subtraction factors may be passed (via the side channel) to the locally adaptive noise reduction function and/or noise model adjustment function, where the factors represent adjustments for the change in variance due to the mixing of the two different signals. For example, noise variance may be adjusted by linearly combining variances of a color and IR signal in proportion to the amount of IR being subtracted. The color and IR signals are independent signals, and each may have its own noise variances. When any kind of subtraction or addition is performed on these signals, their respective noise statistics change. The adaptive IR subtraction operation adds the variances of the two signals multiplied by their gain factors, which represents how noise changes due to that operation, which is what is included as a contributed noise gain factor for a pixel as represented in the accumulation of noise gains provided by the adaptive noise gain map (e.g., via the side channel).

As discussed, the gains applied during local white balance (WB) and color correction (CC) adaptation affect the noise gain, and the noise increase is proportional to the applied WB and/or CC color channel gain. In the same way as the adaptive IR subtraction noise gain, the WB and CC noise gains may be passed (via the side channel) to the noise model adjustment function, which adjusts the noise model (e.g., applies the Sigma noise value curve bias) based on these noise gain factors. White balance factors and color correction matrix coefficients may be provided (via the side channel) to the noise model adjustment function to adjust for the noise gain changes due to these locally varying gains. The noise variance may be adjusted by linearly combining the variances of the different color channels in correct proportion with the local WB and color correction matrix (CCM) factors, as discussed below.

With respect to white balance, the application of a gain to a color channel signal scales the noise in that pixel and can be approximately proportional to the gain applied. For example, in some embodiments the effect on noise gain due to white balance may be described by the expression:

$${σ}_{postWB} ( x , y , ch ) = WB ( ch ) * σ ( x , y , ch )$$

where: ch=Bayer channel (r,g,b), σ(x,y,ch)=original noise at Bayer pixel, and WB(ch)=white balance gain applied to the Bayer channel.

With respect to color correction, the application of a gain to a color channel signal scales the noise in that pixel and can be approximately proportional to the gain applied. For example, for a CC matrix (CCM) may be applied color channels by an ISP pipeline stage as follows:

$$[ \begin{matrix}{r}^{′} \\ {g}^{′} \\ {b}^{′}\end{matrix} ] = [ \begin{matrix}c c {m}_{11} & c c {m}_{12} & c c {m}_{13} \\ c c {m}_{21} & c c {m}_{22} & c c {m}_{23} \\ c c {m}_{31} & c c {m}_{32} & c c {m}_{33}\end{matrix} ] [ \begin{matrix}r \\ g \\ b\end{matrix} ]$$

and the change in variance of color signals due can be estimated from the linear combination of the scaled variances due to the CCM gains. The new signal variances may then be given as follows:

$${σ}_{r}^{′ 2} ( x , y ) = {( c c {m}_{11} * {σ}_{r} ( x , y ) )}^{2} + {( c c {m}_{12} * {σ}_{g} ( x , y ) )}^{2} + {( c c {m}_{13} * {σ}_{b} ( x , y ) )}^{2}$$

$${σ}_{g}^{′ 2} ( x , y ) = {( c c {m}_{21} * {σ}_{r} ( x , y ) )}^{2} + {( c c {m}_{22} * {σ}_{g} ( x , y ) )}^{2} + {( c c {m}_{23} * {σ}_{b} ( x , y ) )}^{2}$$

$${σ}_{b}^{′ 2} ( x , y ) = {( c c {m}_{31} * {σ}_{r} ( x , y ) )}^{2} + {( c c {m}_{32} * {σ}_{g} ( x , y ) )}^{2} + {( c c {m}_{33} * {σ}_{b} ( x , y ) )}^{2}$$

where: σᵣ, σ_{g}, σ_{b} (x,y)=uncorrelated noise variance for Bayer pixels r, g, b, and σ′ᵣ, σ′_{g}, σ′_{b} (x,y)=new estimated noise variance for Bayer pixels r, g, and b. If the variances in noise in the three color channels are similar, the noise gain due to color correction can be further simplified to:

$${σ}_{r}^{′} ( x , y ) = \sqrt{{ccm}_{11}^{2} + {ccm}_{12}^{2} + {cccm}_{13}^{2}} * {σ}_{r} ( x , y )$$

$${σ}_{g}^{′} ( x , y ) = \sqrt{{ccm}_{21}^{2} + {ccm}_{22}^{2} + {cccm}_{23}^{2}} * {σ}_{g} ( x , y )$$

$${σ}_{r}^{′} ( x , y ) = \sqrt{{ccm}_{31}^{2} + {ccm}_{32}^{2} + {cccm}_{33}^{2}} * {σ}_{b} ( x , y ) .$$

Although the adaptive IR subtraction process and local white balance (WB) and color correction (CC) adaptation are discussed herein as example processes that can produce deviant noise gains, it should be understood that other color channel adjustments and/or digital filtering may produce deviant noise gains that may be mitigated by a locally adaptive noise reduction function such as that described herein. For example, a lens shading correction filter may correct for a roll-off in terms of brightness of an image (vignette effects) towards the extremities of the image due to characteristics of the camera lens. Lens shading correction adjusts color channel gains (e.g., radially from a center to the edges) to produce a more uniform brightness. These adjustments thus may introduce additional noise gains that are a function of a pixel's distance from the image center, rather than being uniform across the image. The resulting noise gain factors may be determined as a function of the shading correction, and communicated to the noise model adjustment function (e.g., via the side channel) and accumulated with other noise gain factors produced by other processes (e.g., adaptive IR subtraction process, local white balance (WB) adaptation, and/or color correction (CC) adaptation).

In some embodiments, a locally adaptive noise reduction function may apply spatial techniques to provide further robustness to the computation of noise gain factors and/or an adaptive noise gain map. Since noise gain may change differently for a center pixel as compared to neighborhood pixels (e.g., an n×n pixel region centered around a target image pixel). As such, a pixel-wise derived noise gain map might not reflect the noise gain in the surrounding area. For example, a locally adaptive noise reduction function may estimate noise gain factors based on spatial context, such as by weighing local noise gain statistics in a neighborhood of pixels around a central pixel (e.g., a spatial support window) when computing noise gain factors for that pixel. Noise varies spatially depending on the content and/or adjustments, such as a locally adaptive IR adjustment, and/or locally adaptive white balance and color corrections. In some embodiments, a noise reduction stage of an ISP pipeline may improve on the manner in which it uses a noise model by averaging deviant noise gain variance over a local neighborhood of pixels as opposed to a per-pixel basis. This makes the noise estimation more robust and aware of local variations, for example due to IR and/or color adaptations. An adaptive noise gain map such as discussed herein may then be used to adjust noise gain factors for a given pixel (central) based on incorporating a statistical weighting of noise of pixels in the neighborhood around that pixel. For example, a pixel-centric noise gain estimate may be adjusted using a noise estimation spatial support window based on an expression such as:

$$N {oiseEstimate}_{spatial} ( x , y ) = \frac{1}{{M}^{2}} {\sum }_{o = - M / 2}^{M / 2} {\sum }_{p = - M / 2}^{M / 2} NoiseEstimate ( x + o , y + p )$$

where: x, y=the location of the center pixel, and M=the window for spatial averaging.

In some embodiments, a locally adaptive noise reduction function may apply one or more spatio-temporal techniques to provide robustness to the computation of noise gain factors and/or an adaptive noise gain map. That is, in some embodiments, noise gain estimation may be performed based on image data that comprises multiple image frames captured over a period of time. Spatio-temporal noise gain estimation may be performed based on determining an immediate pixel neighborhood around a pixel (e.g., the pixel's local support region discussed above) and averaging the noise estimates from similar patches in temporal space (e.g., over a set of multiple image frames). Temporal noise estimation may particularly lend itself to applications where it can be assumed that there are some static parts of the image (e.g., static regions of a vehicle interior) that do not vary over time with respect to, for example, local IR adaptation between several consecutive frames, leading to a similarity search across frames. The similarity may be determined based on, for example, segmentation and/or other similarity metrics such as a bilateral averaging of noise gain in a local pixel support region. In some embodiments, a spatio-temporal noise gain estimation may be computed based on an expression such as:

$$N {oiseEstimate}_{spatio - temporal} ( x , y ) = \frac{1}{L} {\sum }_{f = - N}^{0} {\sum }_{o = - M / 2}^{M / 2} {\sum }_{p = - M / 2}^{M / 2} k ( f , x + 0 , y + p ) * {Noise}_{est} ( f , x + o , y + p )$$

where: M=the window for spatial averaging, N=past N+1 frames [−N, −N+1, . . . up to frame=0], k=a similarity matching metric to determine a similarity of averaging patches across frames, and L=a normalization factor for the weighted averaging.

In some embodiments, the locally adaptive noise reduction function may use multi-scale noise estimation. Multi-scale pyramidal analysis can be used effectively to determine similar pixel neighborhoods in even larger search windows (e.g., where the window M is large). Once these similar neighborhoods are determined on a coarse level using a pyramidal approach, the locally adaptive noise reduction function can perform a finer similarity assessment based on segmentation and/or other similarity metrics such as a sum-and-difference process and/or a bilateral interpolation of variances over the larger search window. In some embodiments, a multi-scale approach to noise estimation can be extended to the denoising operation itself and may incorporate frequency-selective denoising.

In some embodiments, an ISP pipeline may be structured as one or more sequential image adjustment stages (e.g., a demosaic stage, a white balance stage, a tone mapping stage, a color correction stage, and/or other stages) where the processed output of one stage is used as the input to the next stage. For image adjustment stages that produce locally adaptive color channel adjustments (such as adaptive IR subtraction, local white balance (WB) and color correction (CC) adaptation stages, lens shading correction, etc.), the resulting pixel-level noise gain factors resulting from those adjustments may be communicated (via the side channel) to a locally adaptive noise reduction function, which may generate the adaptive noise gain map and/or apply the spatial, spatio-temporal, and/or multi-scale noise estimation discussed herein. The noise model adjustment function may then apply the adaptive noise gain map to bias the noise model with respect to the point on the Sigma noise value curve (e.g., by moving up or down the curve) used by the noise reduction stage of the ISP—and thus produce the composite noise gain map.

In some embodiments, one or more functions of the locally adaptive noise reduction function described herein may be implemented as a function of an ISP pipeline embedded in a chip, which inputs a stream of raw pixel data from an image sensor, processes the raw pixel data to compute IR-corrected color channels, and renders (or otherwise generates) an optical image frame comprising pixels based on the IR-corrected color channels. The rendered optical image frame may be presented on a display device for human viewing, used for rendering elements within a virtual environment, and or used for machine vision applications, such as training machine learning models and/or as inputs to machine learning models that perform other operations based on making inferences/predictions based on the optical image frame.

Because image artifacts in the resulting RGB color channels of the IR-corrected optical image frame caused by IR variations are substantially reduced, and because noise gains introduced by localized IR correction and other color channel adjustments (e.g., local white balance and/or color correction adaptation, lens shading correction, etc.) are substantially removed, downstream systems and functions that use the optical image frame as input receive a more accurate representation of the environment captured by the image sensor, and therefore may themselves operate with a greater degree of accuracy. For example, perception networks of an OMS using the resulting IR-corrected optical image frame are less likely to be confused with respect to interpreting occupant behaviors and/or detecting and understanding objects present within the cabin of a vehicle. In some embodiments, the ISP pipeline may perform one or more operations to adjust image parameters of the IR corrected optical image frame such as, but not limited to, white balance correction, tone mapping, demosaicing, color noise reduction, color correction, image sharpening, image scaling, or other image adjustments.

It should be appreciated that the embodiments described herein may be used in the context of occupant monitoring for vehicles such as automobiles, trucks, trains, aircraft, spacecraft, and/or boat, but may extend to other machinery such as remote-operated and/or autonomous devices (e.g., robots and drones), industrial and/or construction machinery, and/or any other image signal processing application such as security, surveillance, night-vision applications, biometric identification applications, and/or area monitoring, using image sensors that capture visible wavelength color data and non-visible wavelength data, such as IR light.

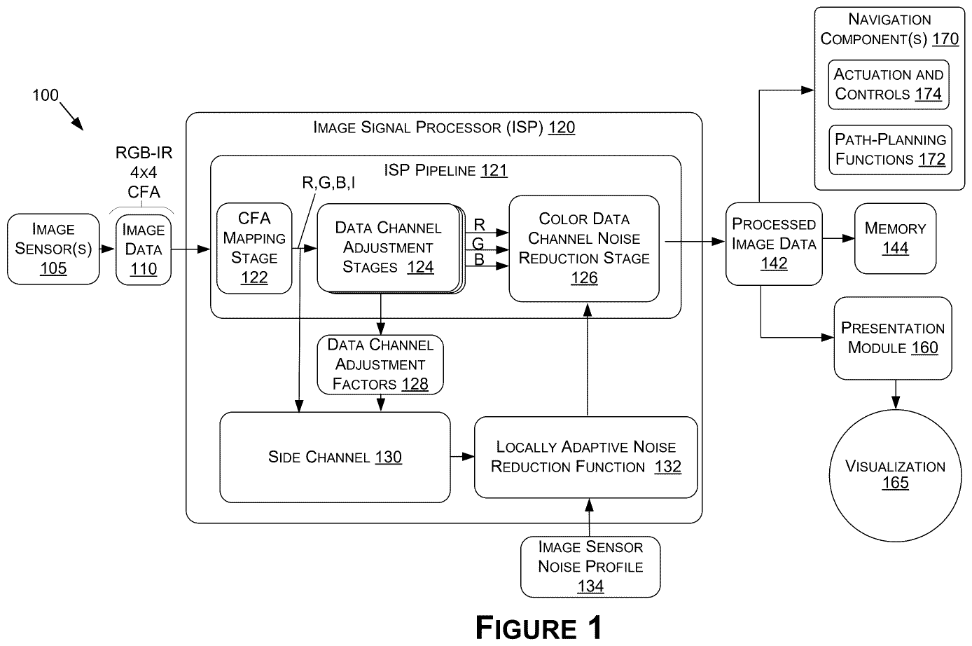

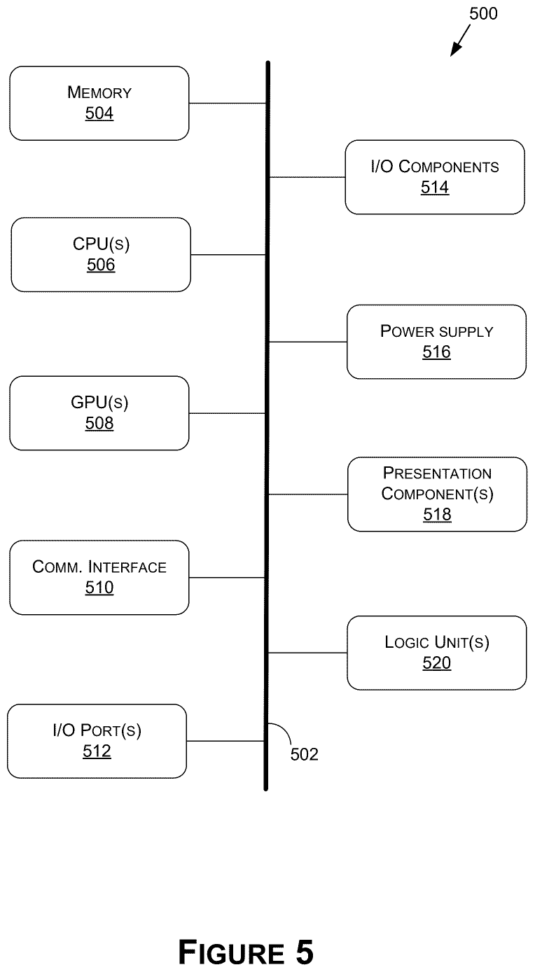

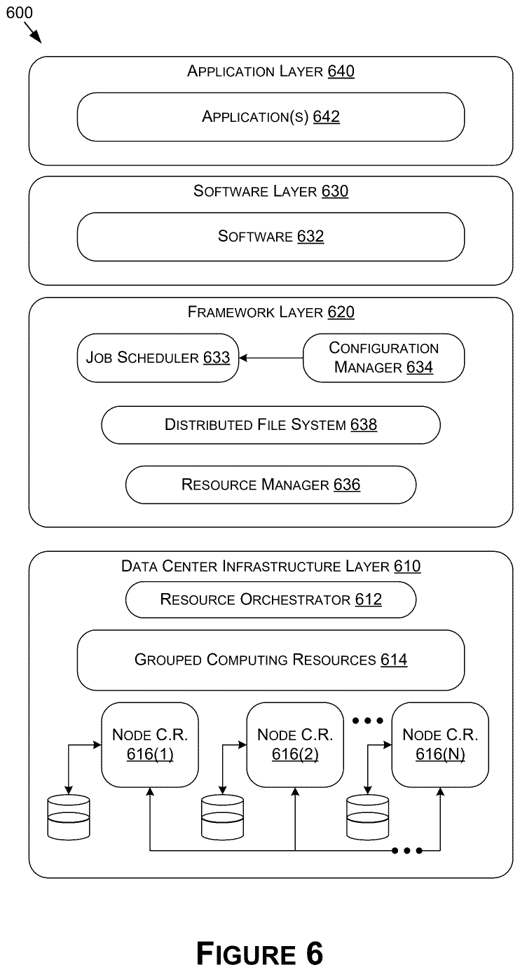

With reference to FIG. 1, FIG. 1 is an example data flow diagram for a process for locally adaptive noise reduction for an adaptive IR correction-based ISP system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors (e.g., one or more processing units comprising processing circuitry) and executing instructions stored in memory. In some embodiments, the systems, methods, and processes described herein may be executed using similar components, features, and/or functionalities to those of example autonomous vehicle 400 of FIGS. 4A-4D, example computing device 500 of FIG. 5, and/or example data center 600 of FIG. 6.

As shown in FIG. 1, an adaptive IR correction-based ISP system 100 may comprise an ISP 120 that includes an ISP pipeline 121 that inputs image data 110 and generates processed image data 142 based on applying one or more image processing adjustments to the image data 110. In some embodiments, the ISP pipeline 121 may include a color filter array (CFA) mapping stage 122 that receives image data 110 and separates the image data into color channel data and IR channel data. The image data 110 may be produced by one or more image sensors 105 (e.g., a camera) that includes a CFA of small color filters placed over the photo-sensitive sensor element of the image sensor assigned to a color channel of the image sensors 105.

Image sensor(s) 105 may include, for example, RGB cameras, IR cameras, RGB-IR cameras, stereo camera arrays, depth cameras, and/or other cameras, such as cameras described with respect to the vehicle 400 of FIGS. 4A-4D. The image sensor(s) 105 may include one or more cameras of an ego object or ego actor, such as stereo camera(s) 468, wide-view camera(s) 470 (e.g., fisheye cameras), infrared camera(s) 472, surround camera(s) 474 (e.g., 360° cameras), occupant monitoring system (OMS) sensor(s) 401, and/or long-range and/or mid-range camera(s) 498 of the autonomous vehicle 400 of FIGS. 4A-4D. The image sensor(s) 105 may be used to generate the image data 110 of the three-dimensional (3D) environment around the ego object or ego actor.

At the pixel level, the CFA filters light so that for each pixel sensor, a designated range of wavelengths—corresponding to a color channel—reaches a given sensor element. A Bayer filter is an example common 2×2 pixel RGB CFA that comprises one blue, one red, and two green filters. In some embodiments, for cameras that capture and generate data for non-visible IR wavelength light, the CFA may further include filter elements that pass the IR wavelength light to pixel sensors. For example, a standard Bayer filter may be adapted for an RGB-IR camera to substitute one of the two green filters with an IR or near-IR wavelength filter. In some embodiments, the image data 110 may have an RGB-IR 4×4 CFA Bayer pattern format. That is, the CFA for an RGB-IR camera may comprise a 4×4 pixel RGB-IR CFA where 2 of 16 pixel filters are red, 2 of 16 pixel filters are blue, 8 of 16 pixel filters are green, and 4 of 16 pixel filters are IR. Although examples of CFA mapping may be described herein with respect to RGB color space, embodiments are not limited to RGB color filter arrays. For example, CFA mapping (e.g., as performed by the CFA mapping stage 122) may, in some embodiments, be performed using other color spaces and color filter arrays such as, but not limited to, RCB (red, clear, blue) and IR, RCG (red, clear, green) and IR, RYCy (red, yellow, cyan) and IR, or other color filter arrays.

In some embodiments, the ISP pipeline 121 may process color channel data received from the CFA mapping stage 122 using a series of data channel adjustment stages 124—which may include, as non-limiting examples, a locally adaptive IR correction function, a locally adaptive color compensation function, one or more image color data channel processing stages, and/or other correction filters such as a lens shading correction function. Within the plurality of data channel adjustment stages 124, the color data channels are mapped into distinct logical color channels, each having a processing path through the data channel adjustment stages 124. The particular processes applied to the visible wavelength color data channels by a data channel adjustment stage 124 may include, but are not limited to, demosaicing, white balance correction, tone mapping, color correction, image sharpening, image scaling, and/or other image adjustments, and so forth as described herein.

As shown in FIG. 1, in the ISP pipeline 121, a color data channel noise reduction stage 126 may be applied to the individual R, G, and B color channels, subsequent to the other adjustments performed by the data channel adjustment stages 124. The noise reduction stage 126 may operate based on an image sensor noise profile 134 corresponding to the expected device noise produced in the image data 110 generated by image sensor 105. For a given signal level, a Sigma noise value may be determined from a Sigma noise value curve represented by the image sensor noise profile 134. Distortion of the noise profile of the image data 110 by locally adaptive operations performed by the data channel adjustment stages 124 introduces a non-uniform noise component not accounted for by the Sigma noise value curve.

To address non-uniform noise components introduced by the data channel adjustment stages 124, pixel-by-pixel IR correction information, and/or color correction information performed by the stages 124 of the ISP pipeline 121 may be passed as data channel adjustment factors 128 (e.g., noise gain factors) via a side channel 130 to the locally adaptive noise reduction function 132. The side channel 130 and/or locally adaptive noise reduction function 132 may cumulatively track, and accumulate noise gains associated with each adjustment to RGB color channels that affect noise gain, which may be used by the locally adaptive noise reduction function 132 to adjust operation of the noise reduction stage 126 to account for noise gain deviations caused by locally adaptive adjustments to the color channels by the data channel adjustment stages 124. The locally adaptive noise reduction function may be implemented as a distinct stage of the ISP pipeline 121, and/or integrated into the standard color data channel noise reduction stage 126. In some embodiments, the locally adaptive noise reduction function 132 executes a noise model adjustment that uses the pixel-by-pixel data channel adjustment factors 128 accumulated by the side channel 130 to dynamically compute supplemental noise adjustments. The supplemental noise adjustments may represent additional noise corrections relative to the noise levels indicated by the image sensor noise profile 134. That is, in some embodiments, the supplemental noise adjustments provide pixel-level noise corrections that are applied by the color data channel noise reduction stage 126 together with corrections indicated by the image sensor noise profile 134—to ensure a more uniform noise reduction is achieved for the entire image while simultaneously restoring colors consistently throughout the image. Application of the supplemental noise adjustments to the image noise data provided by the sensor noise profile 134 may be represented as a composite noise map that is input to the color data channel noise reduction stage 126.

The locally adaptive noise reduction function 132 advantageously adapts the denoising operations applied to the color channel based on various local image processing metrics (e.g., noise gain factors and indicated by the data channel adjustment factors 128), thus robustly providing optimal denoising locally and globally. The locally adaptive noise reduction function 132 provides automatic local denoising adjustment and enhances tuning flexibility so that good image quality (IQ) can be achieved over a much wider range of scenes than global denoising operations can achieve by themselves.

The results of the processes applied by the ISP pipeline 121 may be output from the ISP 120 as processed image data 142. The resulting processed image data 142 output from the ISP pipeline 121 represents the accumulated adjustments to the image data 110 performed by the ISP pipeline 121.

In some embodiments, ISP 120 may receive image data 110 as a (e.g., live or recorded) stream of image data from the image sensor(s) 105. In some embodiments, image data 110 may be previously captured image data provided to the ISP 120 from a memory. The processed image data 142 may be stored to a memory 144 from which it can be read and used as input by one or more other systems or processes such as, but not limited to, further image processing, generating machine language model training data, and/or rendering visualizations.

In some embodiments, a presentation module 160 may render a representation of a visualization 165 of at least a portion of the processed image data 142 (e.g., on a monitor visible to an occupant or operator of the ego object or ego actor). In some embodiments, the presentation module 160 projects the processed image data 142, or a portion thereof, onto a 3D representation of the 3D environment, renders a view of the processed image data 142 from the perspective of a virtual camera, and/or causes presentation of the rendered view as the visualization 165.

In some embodiments, the processed image data 142 may be used by one or more downstream navigation components 170 of an ego machine, such as the controller(s) 536 discussed below. The downstream navigation components 170, for example, may implement functions such as object avoidance navigation functions and/or a world model manager, a path planner, a control component, a localization component, an obstacle avoidance component, an actuation component, and/or the like, to perform operations for controlling the ego machine through an environment. In some embodiments, downstream navigation components 170 may include one or more deep neural networks (DNNs) that generate one or more predictions and/or inferences about the 3D environment based at least on the processed image data 142.

For some embodiments, the downstream navigation components 170 may include at least one or more path-planning functions 172 (such as path-planning functions for ego machine 400) and/or actuation and controls 174 (such as the steering or break actuators or other controllers discussed herein with respect to ego machine 400). For example, the path-planning functions 172 may include a configuration space manager, a freespace manager, a reachability manager, and a path evaluator. The configuration space manager may manage a pose configuration space, which represents poses comprising positions and orientations of the ego machine in its environment. The freespace manager and the reachability manager may process the pose configuration space to determine one or more paths for maneuvering from a current pose to a target pose in the pose configuration space based at least in part on the processed image data 142. The path evaluator may identify one or more proposed or potential paths for the vehicle based at least on the assessment by the reachability manager.

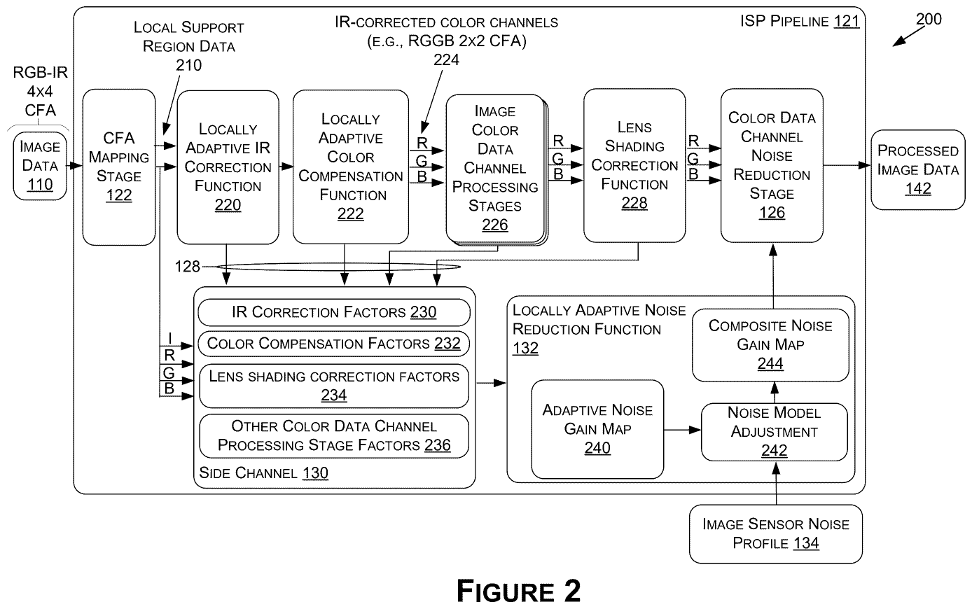

With reference to FIG. 2, FIG. 2 illustrates an example data flow diagram 200 for an ISP pipeline 121, such as is described with respect to the adaptive IR correction-based ISP system 100 of FIG. 1, in accordance with some embodiments of the present disclosure. CFA mapping stage 122 generates an output comprising color channels (e.g., R, G, and B) and an IR channel, which are received by the locally adaptive IR-correction function 220 and may also be provided to the side channel 130. In some embodiments, the CFA mapping stage 122 generates a set of local support region data 210 for use by the locally adaptive IR correction function 220 to define a spatial support window (e.g., an n×n neighborhood of pixels around a central pixel).

On a pixel-by-pixel basis, the local support region data 210 represents a spatial support region for performing locally adaptive functions for a target pixel that is being processed by the ISP pipeline 121 (e.g., for IR correction, color compensation, other image corrections, and/or other locally adaptive adjustments). For individual pixels corresponding to the image data 110, the local support region data 210 may include color channels (e.g., R, G, and B) and/or an IR channel for the target image pixel (e.g., the pixel to which IR correction is being applied), and also the pixel value data (e.g., R, G, and B color data and IR channel data) for each of the other image pixels that define a local support region around the target image pixel.

As previously discussed, in some embodiments, an adaptive IR correction-based ISP system 100 may comprise an ISP pipeline 121 that includes a locally adaptive IR correction function 220 that varies the amount of luminance value subtracted from each color pixel of image data 110 for IR correction purposes, based on tonal and IR to color ratio metrics measured in the vicinity of the pixel in a neighborhood represented by the local support region data 210. The locally adaptive IR correction function 220 may compute channel value estimates for the RGB color channels and an IR channel value estimate for the target image pixel based on spatial filtering. The locally adaptive IR correction function 220 may apply color and IR channel spatial filtering to compute an IR channel estimate, based on spatial filtering of the IR channel within the local support region represented by the local support region data 210 and/or other color channels as well. The spatial filtering applied by the locally adaptive IR correction function 220 may include filtering using one or more of, but not limited to, a smoothing spatial filter, a mean filter, an order statistics filter, a sharpening spatial filter, and/or a derivative filter.

As discussed herein, the effect of adaptive IR subtraction by the locally adaptive IR correction function 220 on the noise variance of a color channel may be expressed as a Sigma function. For example, noise variance may be adjusted by linearly combining variances of a color and IR signal in proportion to the amount of IR being subtracted. The color and IR signals are independent signals and each with its own noise variances. When any kind of subtraction or addition is performed on these signals, their respective noise statistics change. The adaptive IR subtraction operation adds the variances of the two signals multiplied by their gain factors, which represents how noise changes due to that operation, which is what is included as a contributed noise gain factor for a pixel, as represented in the accumulation of noise gains represented by the data channel adjustment factors 128.

Locally adaptive IR adjustments can mitigate image color artifacts by varying the amount of IR subtracted locally based on local tonal level and IR over color ratio metrics but may result in inconsistent color balance in different regions of the image. Such inconsistent color balance may be corrected by commensurate local white balance adaptation and local color correction adaptation applied to color channels by one or more locally adaptive color compensation functions 222 after the locally adaptive IR correction function 220 performs adaptive IR subtraction from the color channels. The gains applied during local white balance (WB) and color correction (CC) adaptation affect the noise gain, and the noise increase is proportional to the applied WB and/or CC color channel gain. In the same way as the adaptive IR subtraction noise gain factors, the WB and CC noise gains may be passed as data channel adjustment factors 128 via the side channel 130 to the locally adaptive noise reduction function 132. For example, white balance factors and color correction matrix coefficients may be provided as factors to the locally adaptive noise reduction function 132 to adjust for the noise gain changes due to these locally varying gains. With respect to white balance and color correction, the application of a gain to a color channel signal scales the noise in that pixel and can be approximately proportional to the gain applied.

Based on the processing by the locally adaptive IR correction function 220 and/or locally adaptive color compensation functions 222, the ISP pipeline 121 produces IR-corrected color channels 224, which may then be further processed by the image color data channel processing stages 226 and/or other processes such as, but not limited to, lens shading correction function 228 and denoising applied by the color data channel noise reduction stage 126.

The IR-corrected color channels 224 may include individually corrected color channels for individual pixels of the image data 110. In some embodiments, IR-corrected color channels 224 include RGB color channels that are mapped to a 2×2 RGB CFA, such as but not limited to a red-green-green-blue (RGGB) Bayer quad pattern. In some embodiments, the ISP pipeline 121 may further process the IR-corrected color channels 224 using a series of image color data channel processing stages 226. Within the plurality of image color data channel processing stages 226, the color data channels are mapped to, and transported through, distinct logical color channels, each having a processing path through the image color data channel processing stages 226. As the color data in the color channels propagates through the image color data channel processing stages 226, each stage applies a filter, transformation, and/or other adjustment to the color channel data, with the processed color channel output of a preceding stage providing the color channel input for the next stage in the sequence of processing stages 226. The processed image data 142 resulting output from the ISP pipeline 121 represents the accumulated adjustments to the image data 110 performed by the image color data channel processing stages 226 based at least on the IR-corrected color channels 224.

The particular processes applied to the visible wavelength color data channels by an image color data channel processing stage 226 may include, but are not limited to, demosaicing, white balance correction, tone mapping, color correction, image sharpening, image scaling, and/or other image adjustments, as described herein. Although adaptive IR subtraction and local white balance (WB) and color correction (CC) adaptation are discussed herein as example processes that can produce deviant noise gains, it should be understood that other color channel adjustments and/or digital filtering performed by an ISP pipeline 121 may produce deviant noise gains that may be mitigated by a locally adaptive noise reduction function, such as is described herein.

In some embodiments, the ISP pipeline 121 may comprise other correction filters, such as but not limited to a lens shading correction function 228. The lens shading correction function 228 may apply locally adaptive adjustments to image pixels to correct for a roll-off in terms of brightness of an image (vignette effects) towards the extremities of the image due to characteristics of the image sensor's 105 camera lens. Lens shading correction adjusts color channel gains (e.g., radially from a center to the edges) to produce a more uniform brightness. These adjustments thus may introduce additional noise gains that are a function of a pixel's distance from the image center, rather than being uniform across the image.

For image adjustment stages of the ISP pipeline 121 that produce locally adaptive color channel adjustments, the data channel adjustment factors 128 (e.g., noise gain factors) resulting from those adjustments may be communicated to the side channel 130 to be communicated to the locally adaptive noise reduction function 132. For example, the side channel 130 may transport IR correction factors 230 representing adjustment by the locally adaptive IR correction function 220, color compensation factors 232 (e.g., local white balance (WB) and color correction (CC) factors representing adjustments by the locally adaptive color compensation function 222, lens shading correction factors 234 representing adjustments by the lens shading correction function 228, and/or other color data channel processing stage factors 236 representing adjustments by other stages and/or filters implemented by the ISP pipeline 121 (e.g., locally adaptive demosaicing and/or tone-mapping functions). The side channel 130 and/or locally adaptive noise reduction function 132 may cumulatively track and accumulate noise gains represented by the data channel adjustment factors 128 so that the locally adaptive noise reduction function 132 may adjust operation of the noise reduction stage 126 to account for noise gain deviations caused by locally adaptive adjustments to the color channels by one or more of the stages of the ISP pipeline 121.

In some embodiments, the locally adaptive noise reduction function 132 executes a noise model adjustment function 242. The noise model adjustment function 242 may use the data channel adjustment factors 128 to dynamically compute supplemental noise adjustments relative to the noise levels indicated by the image sensor noise profile 134. In some embodiments, the locally adaptive noise reduction function 132 generates an adaptive noise gain map 240, which may comprise a noise gain image that correlates pixel-wise with the input image from image data 110. Individual pixel locations on the adaptive noise gain map 240 indicate the accumulated noise gain for each color channel of the corresponding pixel location on the input image due to locally adaptive color channel adjustments performed by stages of the ISP pipeline 121. To implement deviant noise reduction, the noise model adjustment function 242 may compute a composite noise gain map 244 that is derived from adjusting the image sensor noise profile 134 based on the adaptive noise gain map 240. The composite noise gain map 244 may then be used as an input to the color data channel noise reduction stage 126 of the ISP pipeline 121 to control noise corrections applied to the IR-corrected color data channels 224. For example, to produce the composite noise gain map 244, the noise model adjustment function 242 may apply the adaptive noise gain map 240 to bias a Sigma noise value curve from the image sensor noise profile 134 that is used by the color data channel noise reduction stage 126 to adjust for sensor noise. Based on the individual pixel noise gain factors indicated by the adaptive noise gain map 240, the noise model adjustment function 242 may bias—at the individual pixel level—the point on the Sigma noise value curve used by the color data channel noise reduction stage 126 to determine the amount of noise reduction applied to the color channels of a pixel. The composite noise gain map 244 thus may represent an adjusted Sigma noise value curve value adjusted for at the individual pixel level based on the adaptive noise gain map 240. The resulting noise reduction adjustments performed on the image pixel values by the color data channel noise reduction stage 126 thus compensates for both image sensor 105 introduced noise, and noise gain in color channels introduced by ISP pipeline 121 adjustments.

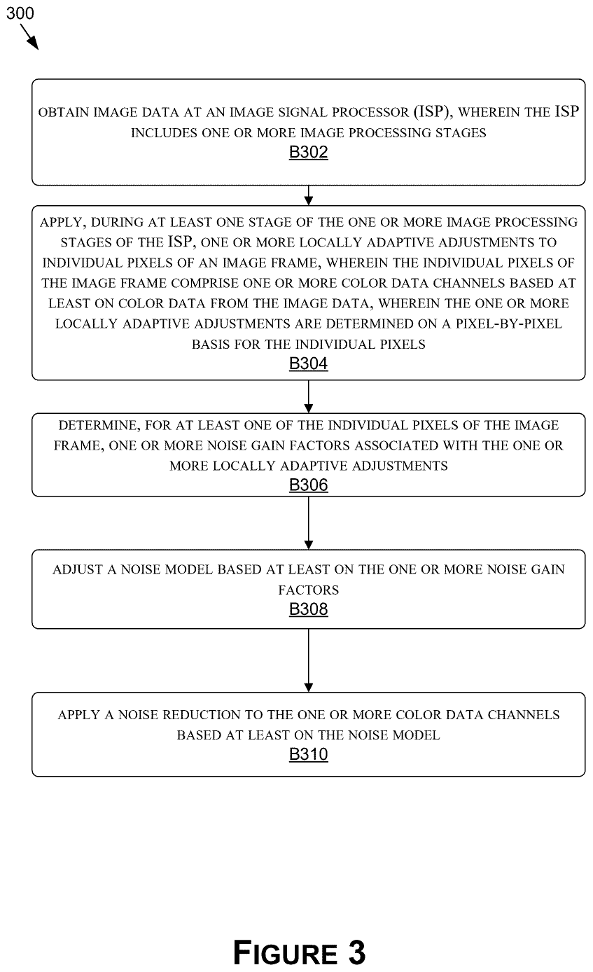

Now referring to FIG. 3, FIG. 3 is a flow diagram showing a method 300 for local adaptive noise reduction for an adaptive IR correction-based ISP, in accordance with some embodiments of the present disclosure. It should be understood that the features and elements described herein with respect to the method 300 of FIG. 3 may be used in conjunction with, in combination with, or substituted for elements of any of the other embodiments discussed herein and vice versa. Further, it should be understood that the functions, structures, and other descriptions of elements for embodiments described in FIG. 3 may apply to like or similarly named or described elements across any of the figures and/or embodiments described herein and vice versa.

Each block of method 300, described herein, comprises a computing process that may be performed using any combination of hardware, firmware, and/or software. For instance, various functions may be carried out by one or more processors (e.g., one or more processing units comprising processing circuitry) executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 300 is described, by way of example, with respect to the adaptive IR correction-based ISP system 100 and/or the ISP 120 of FIG. 1. However, these methods may additionally or alternatively be executed by any one system, or any combination of systems, including, but not limited to, those described herein.

As discussed herein in greater detail, the method may in general include adjusting a noise level for one or more color data channels of individual pixels of an image frame based at least on a noise model, wherein the noise model is adjusted based at least on determining one or more noise gain factors for the individual pixels of the image frame based at least on one or more locally adaptive adjustments to the one or more color channels of individual pixels.

The method 300, at block B302, includes obtaining image data at an image signal processor (ISP), wherein the ISP includes one or more image processing stages. For example, as shown in FIG. 1, an adaptive IR correction-based ISP system 100 may comprise an ISP 120 that includes an ISP pipeline 121 that inputs image data 110 and generates processed image data 142 based on applying one or more image processing adjustments to the image data 110. The image data 110 may be produced by one or more image sensors 105. Image sensor(s) 105 may include, for example, RGB cameras, IR cameras, RGB-IR cameras, stereo camera arrays, depth cameras, and/or other cameras, such as cameras described with respect to the vehicle 400 of FIGS. 4A-4D. The image sensor(s) 105 may be used to generate the image data 110 of a three-dimensional (3D) environment around an ego object or ego actor.

The method 300, at block B304, includes applying, during at least one stage of the one or more image processing stages of the ISP, one or more locally adaptive adjustments to individual pixels of an image frame, wherein the individual pixels of the image frame comprise one or more color data channels based at least on color data from the image data, wherein the one or more locally adaptive adjustments are determined on a pixel-by-pixel basis for the individual pixels. In some embodiments, an optical image sensor may comprise a camera that captures both color and IR image streams (RGB-IR) as image frames. In some embodiments, the ISP pipeline 121 may include a color filter array (CFA) mapping stage 122 that receives image data 110 and separates the image data into color channel data and IR channel data.

In some embodiments, the image data 110 may have an RGB-IR 4×4 CFA Bayer pattern format. That is, the CFA for an RGB-IR camera may comprise a 4×4 pixel RGB-IR CFA where 2 of 16 pixel filters are red, 2 of 16 pixel filters are blue, 8 of 16 pixel filters are green, and 4 of 16 pixel filters are IR. Although examples of CFA mapping may be described herein with respect to RGB color space, embodiments are not limited to RGB color filter arrays. For example, CFA mapping (e.g., as performed by the CFA mapping stage 122) may, in some embodiments, be performed using other color spaces and color filter arrays such as, but not limited to, RCB (red, clear, blue) and IR, RCG (red, clear, green) and IR, RYCy (red, yellow, cyan) and IR, or other color filter arrays.

In some embodiments, the ISP pipeline 121 may process color channel data received from the CFA mapping stage 122 using a series of data channel adjustment stages 124—which may include, as non-limiting examples, a locally adaptive IR-correction function, a locally adaptive color compensation function, one or more image color data channel processing stages, and/or other correction filters such as a lens shading correction function. Within the plurality of data channel adjustment stages 124, the color data channels are mapped into distinct logical color channels, each having a processing path through the data channel adjustment stages 124. The particular processes applied to the visible wavelength color data channels by a data channel adjustment stage 124 may include, but are not limited to, demosaicing, white balance correction, tone mapping, color correction, image sharpening, image scaling, and/or other image adjustments, and so forth as described herein.

The method 300, at block B306, includes determining for at least one of the individual pixels of the image frame, one or more noise gain factors associated with the one or more locally adaptive adjustments. To address a non-uniform noise component introduced by the data channel adjustment stages 124, pixel-by-pixel IR correction information and/or color correction information performed by the stages 124 of the ISP pipeline 121 may be passed as data channel adjustment factors 128 (e.g., noise gain factors) via a side channel 130 to the locally adaptive noise reduction function 132. The side channel 130 and/or locally adaptive noise reduction function 132 may cumulatively track and accumulate noise gains associated with each adjustment to RGB color channels that affect noise gain, which may be used by the locally adaptive noise reduction function 132 to adjust operation of the noise reduction stage 126 to account for noise gain deviations caused by locally adaptive adjustments to the color channels by the data channel adjustment stages 124.

In some embodiments, the method may determine the one or more locally adaptive adjustments for a target pixel based at least on a spatial filtering of one or more color data channels for one or more pixels of a local region comprising at least a plurality of pixels within a proximity around the target pixel. For example, the locally adaptive IR correction function 220 may apply color and IR channel spatial filtering to compute an IR channel estimate, based on spatial filtering of the IR channel within the local support region represented by the local support region data 210 and/or other color channels as well. The spatial filtering applied by the locally adaptive IR correction function 220 may include filtering using one or more of, but not limited to, a smoothing spatial filter, a mean filter, an order statistics filter, a sharpening spatial filter, and/or a derivative filter. In some embodiments, the method may compute the one or more noise gain factors based at least on adjusting a pixel-centric noise gain estimate using a noise estimation spatial support window comprising at least a plurality of pixels. In some embodiments, the one or more noise gain factors may be computed based at least on a spatio-temporal noise gain estimation. Spatio-temporal noise gain estimation may be performed based on determining an immediate pixel neighborhood around a pixel (e.g., the pixel's local support region discussed above) and averaging the noise estimates from similar patches in temporal space (e.g., over a set of multiple image frames). Temporal noise estimation particularly lends itself to applications where it can be assumed that there are some static parts of the image (e.g., static regions of a vehicle interior) that do not vary over time with respect to, for example, local IR adaptation, between several consecutive frames, leading to a similarity search across frames. In some embodiments, the locally adaptive noise reduction function may use multi-scale noise estimation. Multi-scale pyramidal analysis can be used effectively to determine similar pixel neighborhoods in even larger search windows (e.g., where the window M is large). Once these similar neighborhoods are determined on a coarse level using a pyramidal approach, the locally adaptive noise reduction function can perform a finer similarity assessment based on segmentation and/or other similarity metrics such as a sum-and-difference process and/or a bilateral interpolation of variances over the larger search window. In some embodiments, a multi-scale approach to noise estimation can be extended to the denoising operation itself and may incorporate frequency-selective denoising.

The method 300, at block B308, includes adjusting a noise model based at least on the one or more noise gain factors. For example, the method may adjust a Sigma noise value curve of the noise model based on the one or more noise gain factors. In some embodiments, a noise gain map associated with the image frame may be generated based on the one or more noise gain factors, and the noise model adjusted based at least on the noise gain map. The noise gain map may comprise an accumulation of the one or more noise gain factors produced by individual stages of the one or more image processing stages. The one or more noise gain factors may be used to provide an input to the noise model adjustment function via a side channel, wherein the noise model adjustment function adjusts the noise model based on the one or more noise gain factors.

As explained with respect to FIG. 1, to address non-uniform noise components introduced by the data channel adjustment stages 124, pixel-by-pixel IR correction information and/or color correction information performed by the stages 124 of the ISP pipeline 121 may be passed as data channel adjustment factors 128 (e.g., noise gain factors) via a side channel 130 to the locally adaptive noise reduction function 132. The side channel 130 and/or locally adaptive noise reduction function 132 may cumulatively track and accumulate noise gains associated with each adjustment to RGB color channels that affect noise gain, which may be used by the locally adaptive noise reduction function 132 to adjust operation of the noise reduction stage 126 to account for noise gain deviations caused by locally adaptive adjustments to the color channels by the data channel adjustment stages 124. The locally adaptive noise reduction function may be implemented as a distinct stage of the ISP pipeline 121, and/or integrated into the standard color data channel noise reduction stage 126. In some embodiments, the locally adaptive noise reduction function 132 executes a noise model adjustment that uses the pixel-by-pixel data channel adjustment factors 128 accumulated by the side channel 130 to dynamically compute supplemental noise adjustments. In some embodiments, the locally adaptive noise reduction function 132 executes a noise model adjustment function 242. The noise model adjustment function 242 may use the data channel adjustment factors 128 to dynamically compute supplemental noise adjustments relative to the noise levels indicated by the image sensor noise profile 134. In some embodiments, the locally adaptive noise reduction function 132 generates an adaptive noise gain map 240, which may comprise a noise gain image that correlates pixel-wise with the input image from image data 110. Individual pixel locations on the adaptive noise gain map 240 indicate the accumulated noise gain for each color channel of the corresponding pixel location on the input image due to locally adaptive color channel adjustments performed by stages of the ISP pipeline 121. To implement deviant noise reduction, the noise model adjustment function 242 may compute a composite noise gain map 244 that is derived from adjusting the image sensor noise profile 134 based on the adaptive noise gain map 240. The composite noise gain map 244 may then be used as an input to the color data channel noise reduction stage 126 of the ISP pipeline 121 to control noise corrections applied to the IR-corrected color data channels 224.

The method 300, at block B310, includes applying a noise reduction to the one or more color data channels based at least on the noise model. Based on the individual pixel noise gain factors indicated by the adaptive noise gain map 240, the noise model adjustment function 242 may bias—at the individual pixel level—the point on the Sigma noise value curve used by the color data channel noise reduction stage 126 to determine the amount of noise reduction applied to the color channels of a pixel. The composite noise gain map 244 thus may represent an adjusted Sigma noise value curve value adjusted for at the individual pixel level based on the adaptive noise gain map 240. The resulting noise reduction adjustments performed on the image pixel values by the color data channel noise reduction stage 126 thus compensate for both image sensor 105 introduced noise and noise gain in color channels introduced by ISP pipeline 121 adjustments. In some embodiments, the method may generate an output from the ISP (e.g., processed image data 142) based on the one or more color data channels as adjusted by the one or more image processing stages and the noise reduction stage.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, simulated sensor data and/or map data may be used that includes locally adaptive IR-corrected image data within the simulation environment, and the simulation environment may use this information to perform operations (e.g., navigating) associated with the virtual machine within the environment. These simulated operations may be used to test performance of the underlying algorithms, systems, and/or processes prior to deploying them in the real world. In some instances, the simulation may be used to generate synthetic training data—e.g., training data including regions of interest and/or subregions of interest from within the simulation. The synthetic training data (in addition to or alternatively from real-world data) may then be processed to determine geometry and/or other information related to road surfaces, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing a universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to produce processed image data related to animate or static objects, hazards, etc., which may be used or included in a visualization or mapping of an environment to aid a remote operator in controlling—or providing waypoints or other indications of control or navigation—an autonomous or semi-autonomous machine through an environment.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning to enable features such as occupant monitoring, gesture recognition, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as one or more cloud-hosted microservices—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Autonomous Vehicle

FIG. 4A is an illustration of an example autonomous vehicle 400, in accordance with some embodiments of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to allow the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more system on chips (SoCs) 404 (e.g., 404(A), 404(B), FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to allow autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof. In some embodiments, controller(s) 436 may provide signals (e.g., representative of commands) to one or more components and/or systems of the vehicle 400 based at least on processed image data 142.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems (“GNSS”) sensor(s) 458 (e.g., Global Positioning System sensor(s)), RADAR sensor(s) 460, ultrasonic sensor(s) 462, LiDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) (e.g., as part of the brake sensor system 446), one or more occupant monitoring system (OMS) sensor(s) 401 (e.g., one or more interior cameras), and/or other sensor types. In some embodiments, image sensor(s) 105 may comprise one or more of the sensors and/or cameras discussed with respect to FIGS. 4A and 4B.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the High Definition (“HD”) map 422 of FIG. 4C), location data (e.g., the vehicle's 400 location, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.). In some embodiment, visualization 165 may be presented on HMI display 434.

The vehicle 400 further includes a network interface 424 which may use one or more wireless antenna(s) 426 and/or modem(s) to communicate over one or more networks. For example, the network interface 424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 426 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 4B is an example of camera locations and fields of view for the example autonomous vehicle 400 of FIG. 4A, in accordance with some embodiments of the present disclosure. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may be any number (including zero) of wide-view cameras 470 on the vehicle 400. In addition, any number of long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

Any number of stereo cameras 468 may also be included in a front-facing configuration. In at least one embodiment, one or more of stereo camera(s) 468 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned to on the vehicle 400. The surround camera(s) 474 may include wide-view camera(s) 470, fisheye camera(s), 360 degree camera(s), and/or the like. Four example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

Cameras with a field of view that include portions of the interior environment within the cabin of the vehicle 400 (e.g., one or more OMS sensor(s) 401) may be used as part of an occupant monitoring system (OMS) such as, but not limited to, a driver monitoring system (DMS). For example, OMS sensors (e.g., the OMS sensor(s) 401) may be used (e.g., by the controller(s) 436) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 4C is a block diagram of an example system architecture for the example autonomous vehicle 400 of FIG. 4A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C are illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400, and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D). In some embodiment, one or more functions of the ISP 120 and/or ISP pipeline 121 discussed herein to perform locally adaptive noise reduction may be implemented as code executed by one or more of SoC(s) 404, CPU(s) 406 and/or GPU(s) 408.

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation allowing any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 404 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed. In some embodiments, computer vision algorithms may operate based at least on processed image data 142.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LiDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 416 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high-dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to allow communication with peripherals, audio codecs, power management, and/or other devices. The SoC(s) 404 may be used to process data from cameras (e.g., connected over Gigabit Multimedia Serial Link and Ethernet), sensors (e.g., LiDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to allow wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428 which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPS (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated using the RADAR sensor(s) 460) for control and to access object tracking data, with access to Ethernet to access raw data in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surroundings at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 460 m (front) or 80 m (rear), and a field of view of up to 42 degrees (front) or 450 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LiDAR sensor(s) 464. The LiDAR sensor(s) 464 may be used for object and pedestrian detection, emergency braking, collision avoidance, and/or other functions. The LiDAR sensor(s) 464 may be functional safety level ASIL B. In some examples, the vehicle 400 may include multiple LiDAR sensors 464 (e.g., two, four, six, etc.) that may use Ethernet (e.g., to provide data to a Gigabit Ethernet switch).

In some examples, the LiDAR sensor(s) 464 may be capable of providing a list of objects and their distances for a 360-degree field of view. Commercially available LiDAR sensor(s) 464 may have an advertised range of approximately 400 m, with an accuracy of 2 cm-3 cm, and with support for a 400 Mbps Ethernet connection, for example. In some examples, one or more non-protruding LiDAR sensors 464 may be used. In such examples, the LiDAR sensor(s) 464 may be implemented as a small device that may be embedded into the front, rear, sides, and/or corners of the vehicle 400. The LiDAR sensor(s) 464, in such examples, may provide up to a 120-degree horizontal and 35-degree vertical field-of-view, with a 200 m range even for low-reflectivity objects. Front-mounted LiDAR sensor(s) 464 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 400. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may allow the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LiDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 400), while the I2V communication concept provides information about traffic further ahead. CACC systems may include either or both I2V and V2V information sources. Given the information of the vehicles ahead of the vehicle 400, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 460, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network which is trained and thus reduces the risk of false positives, as described herein.

The vehicle 400 may further include the infotainment SoC 430 (e.g., an in-vehicle infotainment system (IVI)). Although illustrated and described as a SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 400. For example, the infotainment SoC 430 may radios, disk players, navigation systems, video players, USB and Bluetooth connectivity, carputers, in-car entertainment, Wi-Fi, steering wheel audio controls, hands free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. As such, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some embodiments of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(D) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road-work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs. In some embodiment, one or more functions of the ISP 120 and/or ISP pipeline 121 discussed herein to perform locally adaptive noise reduction may be implemented as code executed by one or more of CPU(s) 506 and/or GPU(s) 508.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.). In some embodiments, presentation module 160 may comprise one or more of presentation component(s) 518 and/or visualization 165 may be displayed using one or more of presentation component(s) 518.

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM). In some embodiment, one or more functions of the ISP 120 and/or ISP pipeline 121 discussed herein to perform locally adaptive noise reduction may be implemented as code executed by one or more of node C.R.s 616(1)-616(N).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 633, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 633 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 633. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In some embodiments, one or more functions of the ISP 120 and/or ISP pipeline 121 discussed herein to perform locally adaptive noise reduction may be implemented using application(s) 642 and/or software 632.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
obtain image data at an image signal processor (ISP), wherein the ISP includes one or more image processing stages;
apply, during at least one stage of the one or more image processing stages of the ISP, one or more locally adaptive adjustments to individual pixels of an image frame, wherein the individual pixels of the image frame comprise one or more color data channels based at least on color data from the image data, wherein the one or more locally adaptive adjustments are determined on a pixel-by-pixel basis for the individual pixels;
determine, for at least one of the individual pixels of the image frame, one or more noise gain factors associated with the one or more locally adaptive adjustments;
adjust a noise model based at least on the one or more noise gain factors; and
apply a noise reduction to the one or more color data channels based at least on the noise model.

2. The one or more processors of claim 1, wherein the processing circuitry is further to:
adjust a Sigma noise value curve of the noise model based on the one or more noise gain factors.

3. The one or more processors of claim 1, wherein the processing circuitry is further to:
generate a noise gain map associated with the image frame based on the one or more noise gain factors; and
adjust the noise model based at least on the noise gain map.

4. The one or more processors of claim 3, wherein the noise gain map represents the one or more noise gain factors produced by one or more individual stages of the one or more image processing stages.

5. The one or more processors of claim 1, wherein the processing circuitry is further to:
determine the one or more locally adaptive adjustments for a target pixel based at least on a spatial filtering of one or more color data channels for one or more pixels of a local region comprising at least a plurality of pixels within a proximity around the target pixel.

6. The one or more processors of claim 1, wherein the processing circuitry is further to:
communicate the one or more noise gain factors to a noise model adjustment function via a side channel, wherein the noise model adjustment function adjusts the noise model based on the one or more noise gain factors.

7. The one or more processors of claim 1, wherein the one or more locally adaptive adjustments to the individual pixels comprise at least one of: an infrared (IR) subtraction, a local white balance (WB) adaptation, a local color correction (CC) adaptation, a lens shading correction, a demosaic function, and a tone-mapping function.

8. The one or more processors of claim 1, wherein the processing circuitry is further to:
compute the one or more noise gain factors based at least on adjusting a pixel-centric noise gain estimate using a spatial support window comprising at least a plurality of pixels.

9. The one or more processors of claim 8, wherein the processing circuitry is further to:
determine the spatial support window based at least on a multi-scale pyramidal analysis; and
adjust the noise model based at least on frequency-selective denoising.

10. The one or more processors of claim 1, wherein the processing circuitry is further to:
compute the one or more noise gain factors based at least on a spatio-temporal noise gain estimation.

11. The one or more processors of claim 1, wherein the processing circuitry is further to:
generate an output from the ISP based on the one or more color data channels as adjusted by the one or more image processing stages and the noise reduction.

12. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more vision language models (VLMs);
a system implementing one or more large language models (LLMs);
a system implementing one or more multi-modal language models;
a system implemented using one or more cloud-hosted microservices;
a system for generating synthetic data;
a system for generating synthetic data using AI;
a system incorporating one or more virtual machines (VMs);
a system implemented at least partially in a data center; or
a system implemented at least partially using cloud computing resources.

13. A system comprising one or more processors to:
apply, at one or more image processing stages of an image signal processor (ISP), one or more locally adaptive adjustments to one or more color channels of individual pixels of an image frame, wherein the one or more locally adaptive adjustments are determined on a pixel-by-pixel basis for the individual pixels;
determine, for the individual pixels of the image frame, one or more noise gain factors associated with the one or more locally adaptive adjustments;
adjust a noise model based at least on the one or more noise gain factors; and
apply a noise reduction to the one or more color channels based at least on the noise model.

14. The system of claim 13, wherein the noise model comprises a Sigma noise value curve associated with an image sensor that captures image data, wherein the one or more color channels are based at least on color data from the image data.

15. The system of claim 13, wherein the one or more processors are further to:
compute the one or more noise gain factors based at least on adjusting a pixel-centric noise gain estimate using a noise estimation spatial support window comprising at least a plurality of pixels.

16. The system of claim 13, wherein the one or more processors are further to:
compute the one or more noise gain factors based at least on a spatio-temporal noise gain estimation.

17. The system of claim 13, wherein the one or more processors are further to:
generate a noise gain map associated with the image frame based on the one or more noise gain factors; and
adjust the noise model based at least on the noise gain map.

18. The system of claim 13, wherein the one or more locally adaptive adjustments comprise at least one of: an infrared (IR) subtraction, a local white balance (WB) adaptation, a local color correction (CC) adaptation, and a lens shading correction.

19. The system of claim 13, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more vision language models (VLMs);
a system implementing one or more large language models (LLMs);
a system implementing one or more multi-modal language models;
a system implemented using one or more cloud-hosted microservices;
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
adjusting a noise level for one or more color data channels of individual pixels of an image frame based at least on a noise model, wherein the noise model is adjusted based at least on determining one or more noise gain factors for the individual pixels of the image frame based at least on one or more locally adaptive adjustments to the one or more color channels of individual pixels.
